(19) United States
(12) Patent Application Publication
(10) Pub. No.: US 2022/0114287 A1
(43) Pub. Date: Apr. 14, 2022

(54) Privacy Protection Device

(71) Applicant: Emily M. DiSalvo, Albany, NY (US)

(72) Inventor: Emily M. DiSalvo, Albany, NY (US)

(21) Appl. No.: 17/190,789

(22) Filed: Mar. 3, 2021

Related U.S. Application Data
(60) Provisional application No. 63/091,530, filed on Oct. 14, 2020.

(51) Int. Cl. G06F 21/84; H04B 1/3888; G06F 1/16

(52) U.S. Cl. CPC G06F 21/84; G06F 1/1686; G06F 1/1679; H04B 1/3888

(57) ABSTRACT

A privacy protection device for use with a mobile electronic device. The privacy protection device is configured to block the cameras and microphones of the mobile electronic device when not intended for use. The privacy protection device comprises a housing with a plurality of apertures built in for access to the cameras and microphones of the mobile electronic device when in place. A rear camera aperture cover is configured to slidably engage a rear camera aperture to cover the aperture when the rear camera is not needed. A front camera aperture is configured to slidably engage a front camera aperture to cover the aperture when the front camera is not needed. A bottom aperture cover is configured to hinge or snap in place to cover a bottom aperture when the microphone is not needed.

### CROSS-REFERENCE TO RELATED APPLICATION

The present application claims priority to, and the benefit of, U.S. Provisional Application No. 63/091,530, which was filed on Oct. 14, 2020 and is incorporated herein by reference in its entirety.

### FIELD OF THE INVENTION

The present invention generally relates to a device for protecting one's privacy, and more specifically to a privacy protection device for enhancing privacy for a computer or mobile electronic device. Accordingly, the present specification makes specific reference thereto. However, it is to be appreciated that aspects of the present invention are also equally amenable to other like applications, devices and methods of manufacture.

### BACKGROUND OF THE INVENTION

Computers, laptops, tablets, smartphones, and other electronic devices almost always come with integrated cameras and microphones as standard equipment. Cameras and microphones are extremely valuable for the user allowing them to have a more integrated experience in using these electronic devices. Increasingly, business and even personal interactions are facilitated by these tools so that people can interact more authentically from remote locations. Video conferencing and face time applications have become much more common to connect two or more people more effectively.

Many individual cover their laptop computers when the camera or microphone are not needed to increase their privacy from outside access. The devices are shut down, closed, or taped over the camera to prevent unauthorized access. There is a great concern with technology that users are left vulnerable to hackers and artificial intelligence. Currently, there is no quick and easy way to obstruct the camera or microphone on a mobile electronic device, such as a smart phone or a computer tablet with a built in camera and microphone. This leaves individuals vulnerable and concerned about their lack of privacy when using their mobile electronic devices.

In this manner, the improved protective device of the present invention accomplishes all of the forgoing objectives, thereby providing an easy solution to protect one's privacy when using a mobile electronic device. A primary feature of the present invention is a physical barrier that slips on and off of the mobile electronic device effectively blocking the microphone and camera when in place. The protective device is designed to prevent electronic intrusion into the mobile electronic device by a hacker or artificial intelligence without the owner's consent. The privacy protection device is attachable and retrofits to existing mobile electronic devices that have a camera or microphone.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some concepts in a simplified form as a prelude to the more detailed description that is presented later.

The subject matter disclosed and claimed herein, in one embodiment thereof, comprises a privacy protection device for use with a mobile electronic device. The privacy protection device comprises a housing. The housing is configured to retain a portable electronic device. The housing comprises a pair of lateral sidewalls, a top sidewall, and a bottom sidewall. The sidewalls extend around the sides of the portable electronic device. The bottom sidewall comprises a bottom aperture. The bottom aperture is configured to allow access to speakers, microphones, and charging ports that are located within a bottom of the portable electronic device.

The housing further comprises a back. The back connects the pair of lateral sidewalls, the top sidewall, and the bottom sidewall. The back comprises a rear camera aperture. The rear camera aperture is configured to allow access to the rear cameras and sensors located on a back of the portable electronic device. The housing further comprises a front tab. The front tab extends perpendicularly out of and downward from the top sidewall to cover a small portion of the screen of the portable electronic device where the front cameras, speakers, microphones, and sensors are located. The front tab comprises a front camera aperture configured to allow access to the front camera of the portable electronic device. The front tab further comprises a secondary aperture configured to allow access to any additional front cameras, speakers, microphones, and sensors of the portable electronic device.

The privacy protection device further comprises a rear camera aperture cover. The rear camera aperture cover slidably engages the rear camera aperture in the back of the housing. The rear camera aperture cover comprises a rear camera aperture cover slide component. The rear camera aperture cover slide component movably attaches the rear camera aperture cover to the back of the housing. The rear camera aperture cover slide component is configured to move the rear camera aperture cover laterally along the back of the housing so that it completely covers the rear camera aperture when in use and completely exposes the rear camera aperture when not in use. The rear camera aperture cover may further comprise an external gripping element engageable by the user for ease of use.

The privacy protection device further comprises a front camera aperture cover. The front camera aperture cover slidably engages the front camera aperture in the front tab of the housing. The front camera aperture cover comprises a front camera aperture cover slide component. The front camera aperture cover slide component movably attaches the front camera aperture cover to the front tab of the housing. The front camera aperture cover slide component is configured to move the front camera aperture cover laterally along the front tab of the housing so that it completely covers the front camera aperture when in use and completely exposes the front camera aperture when not in use. The front camera aperture cover may further comprise an external gripping element engageable by the user for ease of use.

The privacy protection device may further comprise a front secondary aperture cover. The front secondary aperture cover slidably engages the front secondary aperture in the front tab of the housing. The front secondary aperture cover comprises a front secondary aperture cover slide component. The front secondary aperture cover slide component movably attaches the front secondary aperture cover to the front tab of the housing. The front secondary aperture cover slide component is configured to move the front secondary aperture cover laterally along the front tab of the housing so that it completely covers the front secondary aperture when in use and completely exposes the front secondary aperture when not in use. The front secondary aperture cover may further comprise an external gripping element engageable by the user for ease of use.

The privacy protection device further comprises a bottom aperture cover. The bottom aperture cover engages the bottom aperture in the bottom sidewall of the housing. The bottom aperture cover may comprise a hinge component. The hinge component movably connects the bottom aperture cover to the bottom sidewall of the housing. The bottom aperture cover is hinged over to completely cover the bottom aperture when in use and is hinged away to completely expose the bottom aperture when not in use. Alternatively, the bottom aperture cover may be completely detachable from the housing and may comprise a pair of spring tabs for engaging the bottom aperture to completely cover the bottom aperture when in use.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and is intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a front perspective view of one embodiment of a privacy protection device of the present invention for use with a mobile electronic device in accordance with the disclosed architecture.

FIG. 2A illustrates a rear perspective view of a back camera aperture cover and a bottom aperture cover of the privacy protection device of the present invention in a nonuse configuration in accordance with the disclosed architecture.

FIG. 2B illustrates a rear perspective view of the back camera aperture cover and the bottom aperture cover of the privacy protection device of the present invention in an operating configuration in accordance with the disclosed architecture.

FIG. 3A illustrates a front cutaway perspective view of a front camera aperture cover and a front secondary aperture cover of the privacy protection device of the present invention in a nonuse configuration in accordance with the disclosed architecture.

FIG. 3B illustrates a front cutaway perspective view of the front camera aperture cover and the front secondary aperture cover of the privacy protection device of the present invention in an operating configuration in accordance with the disclosed architecture.

FIG. 4 illustrates a bottom aperture cover of the privacy protection device of the present invention in a nonuse configuration in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They do not intend as an exhaustive description of the invention or do not limit the scope of the invention. Additionally, an illustrated embodiment need not have all the aspects or advantages shown. Thus, in other embodiments, any of the features described herein from different embodiments may be combined.

The present invention, in one exemplary embodiment, is a mobile and electronic device protector. The privacy protection device is a smart phone, tablet, or computer case or attachment that physically covers the integrated cameras and microphones with mechanisms to toggle them on or off depending on usage. The improved case is configured to cover the cameras and microphones of a smart phone or tablet via a sliding insert. The device uses a toggle mechanism to toggle the covers on and off of the cameras and microphones for use. Differing embodiments of the invention are designed to fit a variety of smart phone, tablet, and computer shapes and sizes, as well as options to retrofit existing cases for these electronic devices.

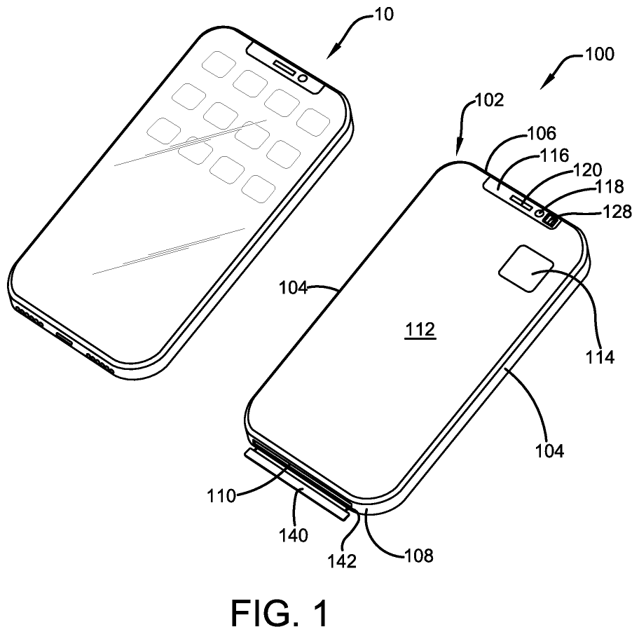

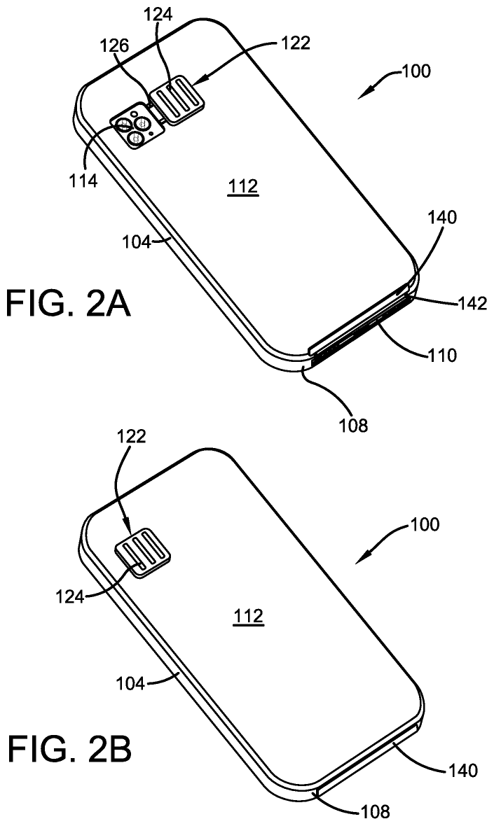

Referring initially to the drawings, FIGS. 1-2B illustrates a privacy protection device 100 for use with a mobile electronic device 10. The mobile electronic device 10 may be a smartphone, a tablet, or any other similar portable mobile electronic tool. The privacy protection device 100 could also be used with other devices used for video platforms such as the Google Nest®, Portal® from Facebook®, Echo® from Amazon®, etc. This may also be used with baby monitors and other home security devices with cameras and mics. Any kind of device that has a camera and/or microphone that one may want to manually disable/cover/muffle the function in the case it is hacked by another person or AI could be protected.

The privacy protection device 100 comprises a housing 102. The housing 102 is configured to retain the mobile electronic device 10. The housing 102 may be constructed from a flexible plastic, rubber, or silicon-based material, or any suitable material as is known in the art. The housing 102 comprises a pair of lateral sidewalls 104, a top sidewall 106, and a bottom sidewall 108. The sidewalls 104, 106, and 108 extend around the sides of the mobile electronic device 10. The bottom sidewall 108 comprises a bottom aperture 110. The bottom aperture 110 is shaped and configured to allow access to any speakers, microphones, or charging ports that are located within a bottom of the mobile electronic device 10.

The housing 102 further comprises a back 112. The back 112 connects the pair of lateral sidewalls 104, the top sidewall 106, and the bottom sidewall 108 to create a protective pocket to surround the back and sides of the mobile electronic device 10. The back 112 comprises a rear camera aperture 114. The rear camera aperture 114 is shaped and configured to allow access to any rear cameras and sensors located on a back of the mobile electronic device 10. The rear camera aperture 114 may be cut into the back 112 in any location needed depending on the number and location of any rear cameras.

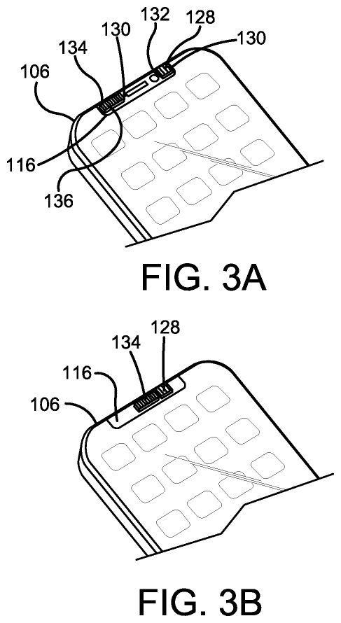

As illustrated in FIGS. 1, 3A, and 3B, the housing 102 further comprises a front tab 116. The front tab 116 extends perpendicularly out of and downward from the top sidewall 106 to cover a small portion of the screen of the mobile electronic device 10 where any front cameras, speakers, microphones, and sensors are located. The front tab 116 comprises a front camera aperture 118 configured to allow access a primary front camera of the mobile electronic device 10. The front tab 116 further comprises a secondary aperture 120 configured to allow access to any additional front cameras, speakers, microphones, and sensors of the mobile electronic device 10.

As illustrated in FIGS. 2A and 2B, the privacy protection device 100 further comprises a rear camera aperture cover 122. The rear camera aperture cover 122 slidably engages the rear camera aperture 114 in the back 112 of the housing 102. The rear camera aperture cover 122 functions as a sliding door and may be manufactured from the same materials as the housing 102. The rear camera aperture cover 122 is sized and shaped to be able to completely cover the rear camera aperture 114 when in use.

The rear camera aperture cover 122 comprises a rear camera aperture cover slide component 126. The rear camera aperture cover slide component 126 movably attaches the rear camera aperture cover 122 to the back 112 of the housing 102. The rear camera aperture cover slide component 126 is configured to move the rear camera aperture cover 122 laterally or vertically along the back 112 of the housing 102 so that it is positional over and completely covers the rear camera aperture 114 when in an operating position as illustrated in FIG. 2B. The rear camera aperture cover slide component 126 is configured to move the rear camera aperture cover 122 laterally or vertically along the back 112 of the housing 102 away from the rear camera aperture 114 as that the rear camera aperture 114 is completely exposed and open when not in use as illustrated in FIG. 2A. The rear camera aperture cover 122 may further comprise an external gripping element 124 engageable by the user for ease of use. The external gripping element 124 may be a series of raised bumps or ridges allowing the user to more easily slide the rear camera aperture cover 122.

As illustrated in FIGS. 1, 3A, and 3B, the privacy protection device 100 further comprises a front camera aperture cover 128. The front camera aperture cover 128 slidably engages the front camera aperture 118 in the front tab 116 of the housing 102. The front camera aperture cover 128 functions as a sliding door and may be manufactured from the same materials as the housing 102. The front camera aperture cover 128 is sized and shaped to be able to completely cover the front camera aperture 118 when in use.

The front camera aperture cover 128 comprises a front camera aperture cover slide component 132. The front camera aperture cover slide component 132 movably attaches the front camera aperture cover 128 to the front tab 116 of the housing 102. The front camera aperture cover slide component 132 is configured to move the front camera aperture cover 128 laterally along the front tab 116 of the housing 102 so that it is positional over and completely covers the front camera aperture 118 when in an operating position as illustrated in FIG. 3B. The front camera aperture cover slide component 132 is configured to move the front camera aperture cover 128 laterally along the front tab 116 of the housing 102 away from the front camera aperture 118 as that the front camera aperture 118 is completely exposed and open when not in use as illustrated in FIG. 3A. The front camera aperture cover 128 may further comprise an external gripping element 130 engageable by the user for ease of use. The external gripping element 130 may be a series of raised bumps or ridges allowing the user to more easily slide the front camera aperture cover 128.

The privacy protection device 100 may further comprise a front secondary aperture cover 134. The front secondary aperture cover 134 slidably engages the front secondary aperture 120 in the front tab 116 of the housing 102. The front secondary aperture cover 134 functions as a sliding door and may be manufactured from the same materials as the housing 102. The front secondary aperture cover 134 is sized and shaped to be able to completely cover the front secondary aperture 120 when in use.

The front secondary aperture cover 134 comprises a front secondary aperture cover slide component 138. The front secondary aperture cover slide component 138 movably attaches the front secondary aperture cover 134 to the front tab 116 of the housing 102. The front secondary aperture cover slide component 138 is configured to move the front secondary aperture cover 134 laterally along the front tab 116 of the housing 102 so that it is positional over and completely covers the front secondary aperture 120 when in an operating position as illustrated in FIG. 3B. The front secondary aperture cover slide component 138 is configured to move the front secondary aperture cover 134 laterally along the front tab 116 of the housing 102 away from the front secondary aperture 120 as that the front secondary aperture 120 is completely exposed and open when not in use as illustrated in FIG. 3A. The front secondary aperture cover 134 may further comprise an external gripping element 136 engageable by the user for ease of use. The external gripping element 136 may be a series of raised bumps or ridges allowing the user to more easily slide the front secondary aperture cover 134.

The privacy protection device 100 further comprises a bottom aperture cover 140 as illustrated in FIGS. 1, 2A, and 2B. The bottom aperture cover 140 engages the bottom aperture 110 in the bottom sidewall 108 of the housing 102. The bottom aperture cover 140 may comprise a hinge component 142. The hinge component 142 movably connects the bottom aperture cover 142 to the bottom sidewall 108 of the housing 102. The bottom aperture cover 140 functions as a hinged door and may be manufactured from the same materials as the housing 102. The bottom aperture cover 140 is sized and shaped to be able to completely cover the bottom aperture 110 when in use.

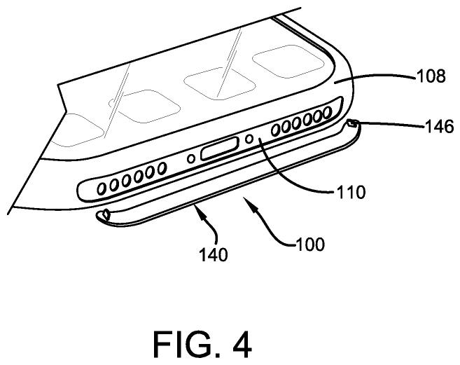

The hinge component 142 is configured to rotate the bottom aperture cover 140 so that it is positional over and completely covers the bottom aperture 110 when in an operating position as illustrated in FIG. 2B. The hinge component 142 is configured to rotate the bottom aperture cover 140 away from the bottom aperture 110 so that the bottom aperture 110 is completely exposed and open when not in use as illustrated in FIG. 2A. Alternatively, as illustrated in FIG. 4, the bottom aperture cover 140 may be completely detachable from the housing 102. The bottom aperture cover 140 may comprise a pair of spring tabs 144 extending perpendicularly from a pair of ends 144 of the bottom aperture cover 140. The pair of spring tabs are flexible for engaging the ends of the bottom aperture 110 to clip in and completely cover the bottom aperture 110 when in an operating position.

Notwithstanding the forgoing, the improved privacy protection device 100 can by any suitable size, shape, and configuration as is known in the art without affecting the overall concept of the invention, provided that it accomplishes the above stated objectives. One of ordinary skill in the art will appreciate that the shape and size of the privacy protection device 100 and its various components, as show in the FIGS. Are for illustrative purposes only, and that many other shapes and sizes of the privacy protection device 100 are well within the scope of the present disclosure. Although dimensions of the privacy protection device 100 and its components (i.e., length, width, and height) are important design parameters for good performance, the privacy protection device 100 and its various components may be any shape or size that ensures optimal performance during use and/or that suits user need and/or preference. As such, the privacy protection device 100 may be comprised of sizing/shaping that is appropriate and specific in regard to the portion of the user's body the privacy protection device 100 is designed to be applied. As technology changes and the designs change, the locations of the camera and/or microphone covers will be dependent on those changes.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A privacy protection device comprising:
a housing comprising a pair of lateral sidewalls, a top sidewall, a bottom sidewall, a back, and a front tab extending perpendicularly downward from the top sidewall;
a rear camera aperture cover slidably engaging a rear camera aperture in the back of the housing; and
a front camera aperture cover slidably engaging a front camera aperture in the front tab of the housing.

2. The privacy protection device of claim 1, wherein the rear camera aperture cover comprises a rear camera aperture cover slide component movably attaching the rear camera aperture cover to the back of the housing.

3. The privacy protection device of claim 1, wherein the rear camera aperture cover is positional over the rear camera aperture to completely cover the rear camera aperture in an operating configuration.

4. The privacy protection device of claim 1, wherein the rear camera aperture cover slides laterally to completely expose the rear camera aperture in a nonuse configuration.

5. The privacy protection device of claim 1, wherein the rear camera aperture cover is a silicon door.

6. The privacy protection device of claim 1, wherein the rear camera aperture cover comprises an external gripping element.

7. The privacy protection device of claim 1, wherein the front camera aperture cover comprises a front camera aperture cover slide component movably attaching the front camera aperture cover to the front tab of the housing.

8. The privacy protection device of claim 1, wherein the front camera aperture cover is positional over the front camera aperture to completely cover the front camera aperture in an operating configuration.

9. The privacy protection device of claim 1, wherein the front camera aperture cover slides laterally to completely expose the front camera aperture in a nonuse configuration.

10. The privacy protection device of claim 1, wherein the front camera aperture cover comprises an external gripping element.

11. A privacy protection device for use with a mobile electronic device, the privacy protection device comprising:
a housing comprising a pair of lateral sidewalls, a top sidewall, a bottom sidewall, a back, and a front tab extending perpendicularly downward from the top sidewall;
a rear camera aperture cover slidably engaging a rear camera aperture in the back of the housing;
a front camera aperture cover slidably engaging a front camera aperture in the front tab of the housing; and
a bottom aperture cover for engaging a bottom aperture in the bottom sidewall of the housing.

12. The privacy protection device of claim 11, wherein the bottom aperture cover comprises a hinge component connecting the bottom aperture to the bottom sidewall of the housing.

13. The privacy protection device of claim 11, wherein the bottom aperture cover is positional over the bottom aperture to completely cover the bottom aperture in an operating configuration.

14. The privacy protection device of claim 11, wherein the bottom aperture cover rotates away from the bottom aperture to completely expose the bottom aperture in a nonuse configuration.

15. The privacy protection device of claim 11, wherein the bottom aperture cover is a silicon door.

16. The privacy protection device of claim 11, wherein the bottom aperture cover is completely detachable from the housing.

17. The privacy protection device of claim 11, wherein the bottom aperture cover comprises a pair of spring tabs for engaging the bottom aperture.

18. A privacy protection device for use with a mobile electronic device, the privacy protection device comprising:
a housing comprising a pair of lateral sidewalls, a top sidewall, a bottom sidewall, a back, and a front tab extending perpendicularly downward from the top sidewall;
a rear camera aperture cover slidably engaging a rear camera aperture in the back of the housing;
a front camera aperture cover slidably engaging a front camera aperture in the front tab of the housing;
a front secondary aperture cover slidably engaging a secondary aperture in the front tab of the housing; and
a bottom aperture cover for engaging a bottom aperture in the bottom sidewall of the housing

19. The privacy protection device of claim 18, wherein the front secondary aperture cover comprises a front secondary aperture cover slide component movably attaching the front camera secondary cover to the front tab of the housing.

20. The privacy protection device of claim 18, wherein the front secondary aperture cover slides laterally to completely expose the front secondary aperture in a nonuse configuration.
